(19) United States
(12) Patent Application Publication
(10) Pub. No.: US 2024/0154449 A1
(43) Pub. Date: May 9, 2024

(54) MANAGEMENT OF ELECTRICAL STORAGE CAPACITY OF BATTERY PACK SYSTEM

(71) Applicant: International Business Machines Corporation, Armonk, NY (US)

(72) Inventors: Rami Jaber, Kildeer, IL (US); Marc Henri Coq, Hopewell Junction, NY (US); Eric B. Swenson, Pine Island, MN (US); Mark E. Maresh, Oro Valley, AZ (US)

(21) Appl. No.: 18/052,549

(22) Filed: Nov. 3, 2022

(51) Int. Cl. H02J 7/00; H01M 10/0525; H01M 10/42; H01M 10/44; H01M 10/48; H01M 50/509

(52) U.S. Cl. CPC H02J 7/007194; H01M 10/0525; H01M 10/425; H01M 10/441; H01M 10/443; H01M 10/486; H01M 50/509; H02J 7/0024; H02J 7/0048; H01M 2010/4271; H02J 2203/20

(57) ABSTRACT

Managing battery cells in a battery pack circuit for reducing stored energy can include a plurality of battery packs electrically connected in a circuit in a battery system to provide a system output voltage. Each of the battery packs include a plurality of battery cells connected in an electrically conductive circuit, and each of the battery packs generate a pack output voltage collectively resulting in the system output voltage. In response to detecting when a cell of the plurality of battery cells of a battery pack of the battery packs approaches a threshold of a thermal state related to battery capacity, discharging electrical capacity of remaining cells in the battery pack thereby reducing available energy in the battery pack.

### BACKGROUND

The present disclosure relates to computer management of a battery pack system or circuit by reducing available battery storage capacity and/or electric charge in one or more battery packs in the battery pack system.

Thermal runaway (TR) propagation in a battery pack such as a lithium-ion battery pack or battery circuit can cause thermal consequences that may reduce effectiveness of the battery pack or damage the battery pack.

Various techniques are used to mitigate thermal runaway of a battery cell and/or battery circuit of cells including Lithium-Ion Batteries. The mitigation strategies function at the material level, cell level, and system level. Techniques can include thermal insulation, reinforced heat dissipation, and fast discharging of adjacent cells in a circuit of battery cells.

In one example, Lithium-Ion (Li-ion) batteries can be used as an energy storage device used in many computing, automotive, and electrical grid applications. Li-ion cells can fail, which can range from disabling the cell's output voltage to causing catastrophic results. Thermal runaway is one such failure mechanism that can lead to destructive events, and can also cause cascading failures to adjacent cells within a battery pack, thereby multiplying the destruction/failure. Examples of failure mechanisms are overheating, internal short circuits, and improper charging of cells.

### SUMMARY

The present disclosure recognizes the shortcomings and problems associated with current techniques for managing battery cells in a battery pack circuit for reducing available capacity of a failed battery pack or one or more battery cells in a battery pack.

Embodiments of the present invention include techniques for controlling battery packs during failure events including Li-ion battery packs during failure events to reduce the potential impacts of thermal runaway. Examples include techniques for discharging adjacent cells while not adding additional risk of thermal runaway to the failed cell.

In an aspect according to the present invention, a method for managing battery cells in a battery pack circuit for reducing stored energy includes electrically connecting a plurality of battery packs in a circuit in a battery system providing a system output voltage. Each of the battery packs includes a plurality of battery cells connected in an electrically conductive circuit, and each of the battery packs generating a pack output voltage collectively resulting in the system output voltage. In response to detecting when a cell of the plurality of battery cells of a battery pack of the battery packs meets a threshold of a thermal state related to battery a capacity, discharging electrical capacity of remaining cells other than the cell in the battery pack, thereby reducing available energy in the battery pack.

In a related aspect, the method further includes electrically isolating the cell which approached the threshold of the thermal state; and maintaining the electrically conductive circuit of the remaining cells in the battery pack.

In a related aspect, the method includes boosting a pack output voltage of the remaining cells to an output voltage usable to the battery system.

In a related aspect, the usable output voltage is within a range of voltages.

In a related aspect, the method further includes discontinuing electrical continuity of the cell within the plurality of battery cells connected in the electrically conductive circuit.

In a related aspect, the discontinuing of the electrical continuity of the cell includes removing charging and discharging capabilities, respectively, of the cell.

In a related aspect, the method further includes electrically disconnecting the battery pack from the battery system; boosting a pack output voltage of the remaining cells to an output voltage usable to the battery system; and reconnecting the battery pack to the battery system.

In a related aspect, the thermal state of the cell is a thermal runaway state of the cell.

In a related aspect, the reduction of the available energy in the battery pack reduces the likelihood of the thermal runaway state of the cell initiating a thermal runaway state in the remaining cells of the battery pack.

In a related aspect, the battery packs can be Li-Ion (Lithium Ion) battery packs.

In a related aspect, the battery packs are connected in parallel in the battery system.

In a related aspect, the battery cells are connected in a parallel-series configuration.

In a related aspect, the method further includes electrically connecting the remaining cells using a multiplexer.

In a related aspect, the method further includes discharging electric capacity of the cell.

In a related aspect, the method further includes a computer system managing the electrically connecting of the plurality of battery packs in the circuit in the battery system, and the computer system managing the discharging of the electric capacity of the remaining cells in response to the detecting when the cell meets the threshold of the thermal state.

In a related aspect, the method further includes receiving, at the computer system, data input from the battery system indicating a connection state of the battery packs in the circuit; receiving, at the computer system, cell data input from each of a plurality of cells of each of the battery packs; and determining, at the computer system, in response to the detecting when the cell meets the threshold of the thermal state, the discharging of the electric capacity of the remaining cells in the battery pack.

In a related aspect, the method further includes generating a digital model, using a computer, the digital model simulating the functions of; the connecting of the plurality of battery pack in the circuit in the battery system; and the discharging of the electric capacity of remaining cells in the battery pack in response to the detecting when the cell meets the threshold of the thermal state.

In a related aspect, the method further includes iteratively generating the digital model to produce updated models.

In another aspect according to the present invention, a system for managing battery cells in a battery pack circuit for reducing stored energy includes: a computer system comprising; a computer processor, a computer-readable storage medium, and program instructions stored on the computer-readable storage medium being executable by the processor, to cause the computer system to perform the following functions to; connect electrically a plurality of battery packs in a circuit in a battery system providing a system output voltage, each of the battery packs including a plurality of battery cells connected in an electrically conductive circuit, each of the battery packs generating a pack output voltage collectively resulting in the system output voltage; a device electrically communicable with the circuit being capable of detecting a battery capacity of a cell of the plurality of battery cells of a battery pack; and in response to a detection, using the device, when the cell of the battery pack meets a threshold of a thermal state related to a battery capacity, discharge electrical capacity of remaining cells other than the cell in the battery pack, thereby reducing available energy in the battery pack.

In another related aspect according to the present invention, a computer program product for managing battery cells in a battery pack circuit for reducing stored energy, includes the computer program product comprising a computer readable storage medium having program instructions embodied therewith. The program instructions are executable by a computer to cause the computer to perform functions, by the computer, comprising the functions to; connect electrically a plurality of battery packs in a circuit in a battery system providing a system output voltage, each of the battery packs including a plurality of battery cells connected in an electrically conductive circuit, each of the battery packs generating a pack output voltage collectively resulting in the system output voltage; and
in response to detecting when a cell of the plurality of battery cells of a battery pack of the battery packs meets a threshold of a thermal state related to a battery capacity, discharging electrical capacity of remaining cells other than the cell in the battery pack, thereby reducing available energy in the battery pack.

In another aspect according to the present invention, an electronic circuit for managing battery cells in a battery pack circuit for reducing stored energy includes a plurality of battery packs electrically connected in a circuit in a battery system to provide a system output voltage. Each of the battery packs includes a plurality of battery cells connected in an electrically conductive circuit, and each of the battery packs being generative of a pack output voltage collectively resulting in the system output voltage. A device can be electrically communicable with the circuit and capable of detection of a battery capacity when a cell of the plurality of battery cells of a battery pack of the battery packs meets a threshold of a thermal state related to the battery capacity. The device can have the capability to initiate discharge of electrical capacity of remaining cells other than the cell in the battery pack, thereby reducing available energy in the battery pack.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1A is a schematic block diagram illustrating a system according to an embodiment of the present disclosure, for managing battery cells in a battery pack circuit for reducing stored energy.

FIG. 1B is a schematic block diagram illustrating a battery pack architecture of a battery pack shown in FIG. 1A.

FIG. 2 is a flow chart of a method, according to an embodiment of the present disclosure, which can use the system depicted in FIG. 1A and further illustrated in FIG. 1B, for managing battery cells in a battery pack circuit for reducing stored energy.

FIG. 3 is a schematic block diagram of a system, according to another embodiment of the present disclosure, for managing battery cells in a battery pack circuit for reducing stored energy.

FIG. 4 is a flow chart illustrating a method according to an embodiment of the present invention which can use the system depicted in FIG. 3, for managing battery cells in a battery pack circuit for reducing stored energy.

FIG. 5 is a schematic block diagram depicting a computer system according to an embodiment of the disclosure, which includes cloud computing components and functions, and which can cooperate with the systems and methods shown in the figures and described herein.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### Embodiments and Examples

Embodiments and figures of the present disclosure may have the same or similar components as other embodiments. Such figures and descriptions illustrate and explain further examples and embodiments according to the present disclosure. Embodiments of the present disclosure can include operational actions and/or procedures. A method, such as a computer-implemented method, can include a series of operational blocks for implementing an embodiment according to the present disclosure which can include cooperation with one or more systems shown in the figures. The operational blocks of the methods and systems according to the present disclosure can include techniques, mechanism, modules, and the like for implementing the functions of the operations in accordance with the present disclosure. Similar components may have the same reference numerals. Components can operate in concert with a computer implemented method.

It is understood that a customer can be an individual, or a group of individuals, or a company or an organization.

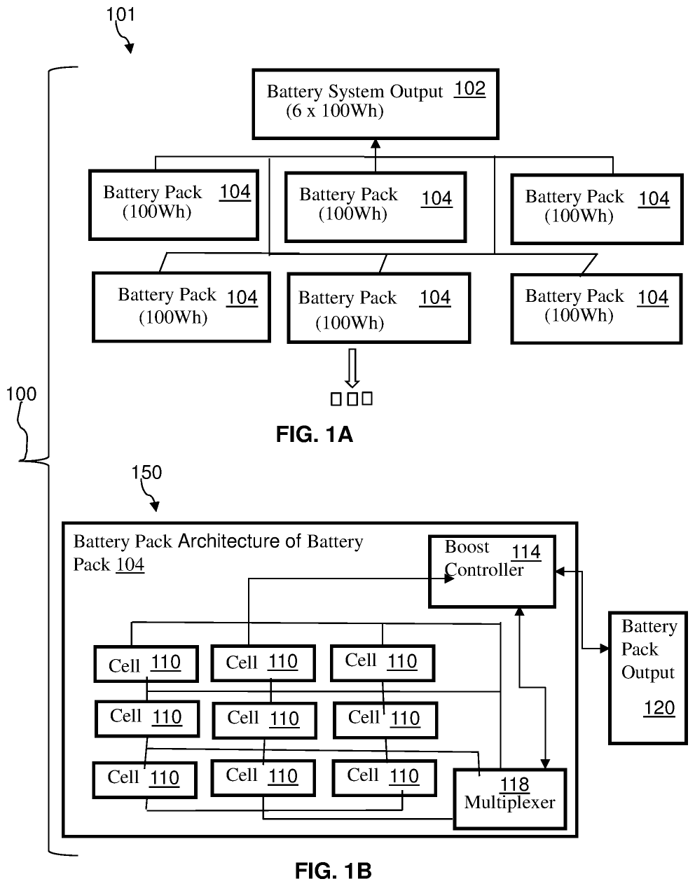

Referring to FIGS. 1A and 1B, according to an embodiment of the present disclosure, a battery pack control system 150 includes a battery pack architecture for a battery pack 104. The system 150 includes a plurality of battery cells 110, a boost controller 114, and a multiplexer 118 to control battery pack output 120 from the battery pack 104. The system 150 can be used for managing battery cells in each of a plurality of battery packs 104 in a battery pack circuit 100 for reducing available capacity of a failed battery pack and/or one or more battery cells 110 in a battery pack 104. The battery pack circuit 100 includes a plurality of battery packs electrically connected and which can be scaled up or down to include more or less battery packs. The battery pack circuit comprising the battery packs 104 collectively produces a battery system 100 output 102, for example, the circuit 101 of the system 100 includes six battery packs.

A battery pack architecture of a battery pack 104 can include a plurality of cells 110. The cells are electrically connected and connected to a multiplexer 118 and a boost controller 114 to control a battery pack output 120.

In one example a Li-ion Battery System can be built using several modular Li-ion Battery Packs that are connected in parallel and can be individually controlled, as shown in FIG. 1A. Within the Li-ion Battery Packs, individual Li-ion Cells 110 are present in a parallel-series configuration, as in FIG. 1b. The architecture shown in FIG. 1B allows individual battery packs to be substituted in and out of the battery system. Upon detection of a cell approaching thermal runaway conditions (which can be referred to as a failed cell), an algorithm stored on computer readable storage medium and executable by a processor or a computer, activates to safely discharge the capacity of the remaining cells in the battery pack to reduce the available energy that could be triggered in a thermal runaway event. The system enables the discharge of cells by electrically isolating the failed cell and connecting the remaining good cells together to the battery output via a multiplexer 118 circuit. A boost converter topology using a boost controller 114 can boost the remaining cell voltages to an output voltage usable by the system application, so that the remaining cells can be discharged into the system as battery pack output 120. Once this discharge is complete, the failed battery pack is permanently taken offline from the battery system by removing its charging and discharging capability.

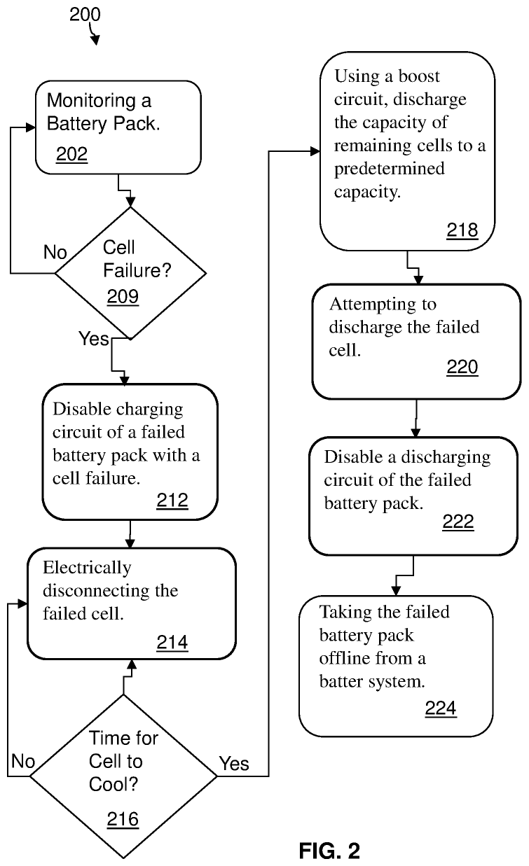

Referring to FIG. 2, a computer implemented method 200 for managing battery cells 110 in a battery pack circuit for reducing electrical stored energy in the circuit and/or an electric charge in one or more batteries, and which can use the battery pack control system 150 shown in FIG. 1B, including monitoring a battery pack 104, as in block 202. The method provides a technique where the remaining cells in a failed battery pack are discharged to a predetermined state of charge level, while not discharging the failed cell. The discharge will be closely monitored and regulated so that it is performed as safely and quickly as possible.

When the method does not detect a cell failure in a battery pack at block 209, the method returns to monitoring a battery pack at block 202. When the method detects a cell failure in a battery pack at block 209, the method continues to block 212 to disable a charging circuit of a failed battery pack having the cell failure. The method includes electrically disconnecting the failed cell as in block 214. In one example, the method can disconnect only the failed cell in a series or circuit of cells which comprises the battery pack.

The method includes allowing a specified time for the failed cell to cool, as in block 216. When the cell needs more time to cool, the method maintains the disconnecting the failed cell. When the cell has completed a specified time to cool at block 216, the method continues to block 218.

The method includes using a boost circuit to discharge the capacity of remaining cells in the battery pack to a predetermined state of charge level (SOC), as in block 218. The boost circuit can begin discharging the remaining cells at a rate it initially deems safe. However, if thermal monitoring shows the remaining cell temperatures begin rising at an unacceptable rate, then the boost circuit can take action to reduce the discharge current until the cell temperatures approach a safe equilibrium level. The boost circuit voltage is another setting that can be adjusted to maintain a safe discharge procedure. At the end of the discharge, the recommended state of charge level can be between 20% and 30% SOC.

The method includes attempting to discharge the failed cell at block 220. Discharging may not be possible due to why the cell is overcharging, e.g., exceeding a threshold of a battery capacity.

The method includes disabling the discharging circuit of the failed battery pack, as in block 222. The method includes taking the failed battery pack offline from a battery system including the battery pack, as in block 224.

Thereby, according to the above example, the method can reduce the risk of thermal runaway by quickly reducing the capacity of the cells surrounding the bad cell to avoid propagation of the thermal event to the surrounding cells (as well as an entire battery assembly). Thereby, the method further reduces the risk of a thermal event on the bad cell by electrically isolating the cell, waiting some time to cool the cell, and disabling the charge and discharge functions of the battery pack after the discharge, as in block 22 of the method 200.

Embodiments according to the present disclosure include methods on how to implement a battery discharge include safely discharging adjacent cells while not adding additional risk of thermal runaway to the failed cell. The discharge of each battery cell can be controlled using a boost circuit to adjust the voltage while monitoring the current draw from each cell. Thereby, a safe discharge is possible. The multiplexer circuit can choose and prioritize the appropriate cells for discharge.

In one example, according to the present disclosure, a series of switches can isolate a failed cell in a cell group. A boost converter can be used to discharge the remaining cells in that group at a safe rate while the system is running until they are at a safe stored energy level. The boost converter can boost the voltage of the remaining cells so that the battery pack can discharge power into the system.

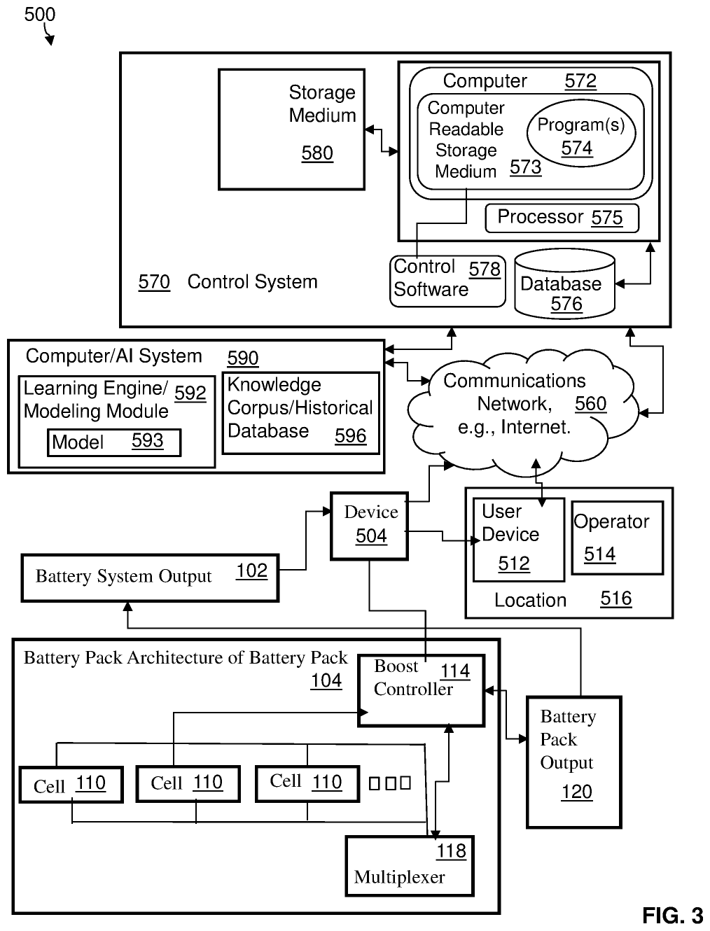

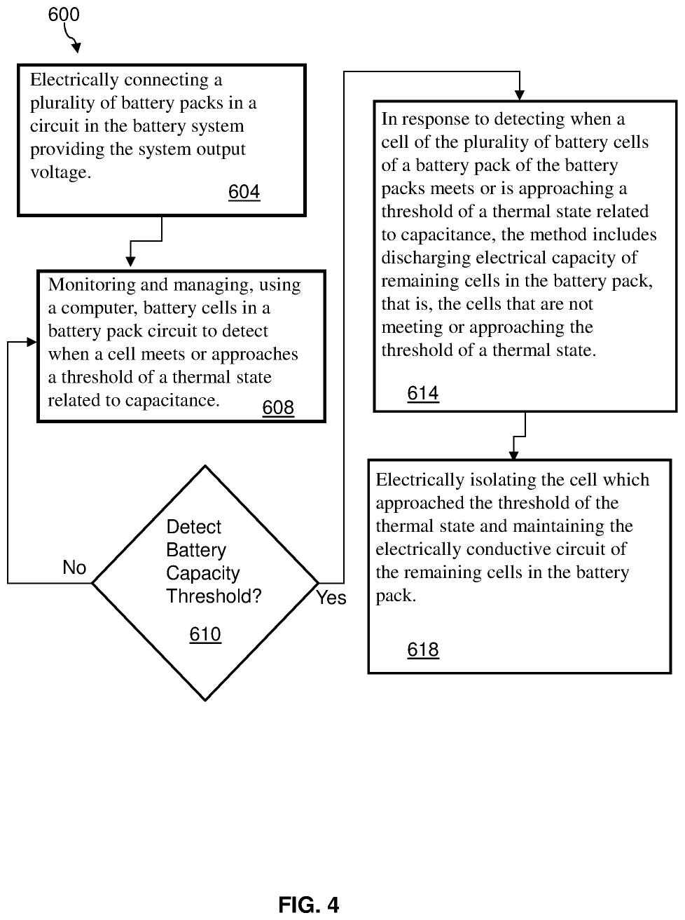

Referring to FIGS. 3 and 4, according to an embodiment of the present disclosure, a method 600 using a system 500 can manage battery cells in a battery pack circuit for reducing available capacity of a failed battery pack. Also, with reference to the circuit 101 and the system 150 shown in FIGS. 1A and 1B, respectively, the system 500 includes the battery pack 104 and the cells 110 generating a battery pack output 120. A plurality of battery pack and respective outputs generate a battery system output 102 which can be used by a device 504.

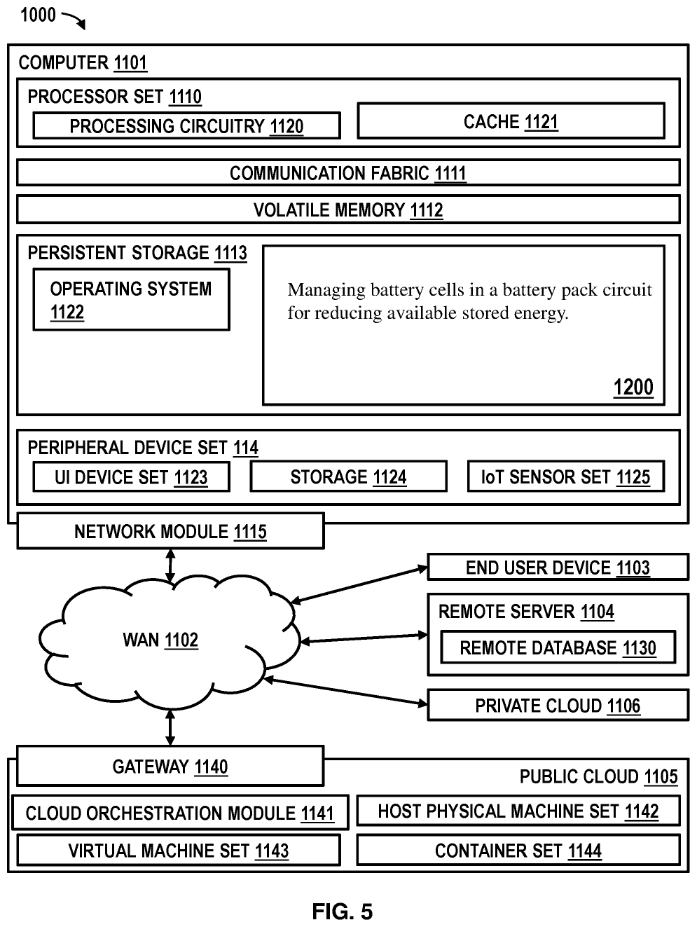

The device can include a motor or electrically generated device, and include or be electrically and communicatively connected to a computer, which can be local to the device or remote. In one example, the computer of the device 504 can communicate with a user device 512 for use by an operator 514 located at a location 516. The device 504 and/or the user device 512 can also communicate with a communications network 560, for example, the Internet. The device 504 and the user device 512 can include a computer having components as shown in a computer system 1000 (FIG. 5). Such devices can communicate with the Internet 560 and communicate with remote computers and data storage devices. In one example, a remote computer/AI (Artificial Intelligence) system 590 and a control system 570 can communicate with the device via the network 560.

In one or more examples, the battery pack circuit 100 can operate as described above, and in another example, the battery pack circuit 100 can be monitored using a computer system to monitor the battery pack and system output, and also controlling the boost controller and multiplexer.

The method 600 includes using the system for electrically connecting a plurality of battery packs 104 in a circuit 100 in the battery system 102 providing the system output voltage 102, as in block 604. Each of the battery packs 104 include a plurality of battery cells 110 connected in an electrically conductive circuit. Each of the battery packs generate a pack output voltage 120 collectively resulting in the system output voltage 102.

Monitoring and managing, using a computer, battery cells in a battery pack circuit to detect when a cell meets or approaches a threshold of a thermal state related to a battery capacity, as in block 608. In one example, the thermal state of the cell can be a thermal runaway state of the cell.

The method includes detecting when a battery capacity threshold is met or approached in block 610. When the threshold is not detected, the method returns to block 608. When the threshold is detected at block 610, the method proceeds to block 614.

In response to detecting when a cell of the plurality of battery cells of a battery pack (of the plurality of battery packs) meets or is approaching a threshold of a thermal state related to a battery capacity, the method includes discharging electrical capacity (and/or an electric charge level) of remaining cells in the battery pack, as in block 614. For example, the cells that are not meeting or approaching the threshold of a thermal state. Thereby, the method and system reduces available energy in the battery pack. The method can also designate the cell that meets or is approaching a threshold of a thermal state as a problem cell.

The method includes electrically isolating the cell which approached the threshold of the thermal state, and maintaining the electrically conductive circuit of the remaining cells in the battery pack, as in block 618.

The method 600 can include boosting a pack output voltage of the remaining cells to an output voltage usable to the battery system. In one example, the usable output voltage can be within a range of voltages. In another example, the method can include discontinuing electrical continuity of the cell within the plurality of battery cells connected in the electrically conductive circuit. The discontinuing of the electrical continuity of the cell can include removing charging and discharging capabilities, respectively, of the cell.

In another example, the method can include electrically disconnecting the battery pack from the battery system; boosting a pack output voltage of the remaining cells to an output voltage usable to the battery system; and reconnecting the battery pack to the battery system. In one example, the thermal state of the cell is a thermal runaway state of the cell. In another example, the reduction of the available energy, for example from a battery capacity, in the battery pack reduces the likelihood of the thermal runaway state of the cell initiating a thermal runaway state in the remaining cells of the battery pack. In one example, the battery packs can be Li-Ion (Lithium Ion) battery packs. In another example, the battery packs can be connected in parallel in the battery system. In another example, the battery cells can be connected in a parallel-series configuration. In another example, the method includes electrically connecting the remaining cells using a multiplexer. In another example, the method can include discharging electric capacity of the cell, for example, the problem cell, that is the cell approaching or meeting the thermal threshold.

In another example, the method can include a computer system managing the electrically connecting of the plurality of battery packs in the circuit in the battery system. The method further includes the computer system managing the discharging of the electrical capacity of the remaining cells in response to the detecting when the cell meets the threshold of the thermal state. In another example, the method can further include receiving, at the computer system, data input from the battery system indicating a connection state of the battery packs in the circuit. The method includes receiving, at the computer system, cell data input from each of a plurality of cells of each of the battery packs. Further, the method includes determining, at the computer system, in response to the detecting when the cell meets the threshold of the thermal state, the discharging of the electrical capacity of the remaining cells in the battery pack.

In one example, the method can further include generating a digital model, using a computer, where the digital model simulates the function of connecting of the plurality of battery pack in the circuit in the battery system. Further, the digital model simulates the function of discharging of the electrical capacity of remaining cells in the battery pack in response to the detecting when the cell meets the threshold of the thermal state. The method further includes iteratively generating the digital model to produce updated models.

In one embodiment according to the present disclosure, and with reference to the figures, a system for managing battery cells in a battery pack circuit 100 for reducing stored energy in the circuit which can included the compromised or failed battery pack 104 can include a computer system. The computer system can include a computer processor, a computer-readable storage medium, and program instructions stored on the computer-readable storage medium being executable by the processor, to cause the computer system to perform the following below functions to connect electrically a plurality of battery packs in a circuit in a battery system providing a system output voltage. Each of the battery packs can include a plurality of battery cells connected in an electrically conductive circuit, and each of the battery packs generate a pack output voltage collectively resulting in the system output voltage. A device is electrically communicable with the circuit being capable of detecting an electric capacity of a cell of the plurality of battery cells of a battery pack. In response to a detection, using the device, when the cell of the battery pack meets a threshold of a thermal state related to the electrical capacity, the system discharges electric capacity of remaining cells other than the cell in the battery pack, thereby reducing available energy in the battery pack.

In one embodiment according to the present disclosure, and with reference to the figures, a computer program product for managing battery cells in a battery pack circuit for reducing stored energy can include a computer readable storage medium 573 having program instructions embodied therewith, the program instructions executable by a computer, for example, computer 572, to cause the computer to perform functions, by the computer, comprising the functions below to connect electrically a plurality of battery packs 104 in a circuit 101 in a battery system 100 which provides a system output voltage 102. Each of the battery packs can include a plurality of battery cells connected in an electrically conductive circuit, and each of the battery packs can generate a pack output voltage collectively resulting in the system output voltage. In response to detecting when a cell of the plurality of battery cells of a battery pack of the battery packs meets a threshold of a thermal state related to a battery capacity, the product can discharge electrical capacity of remaining cells other than the cell in the battery pack, thereby reducing available energy in the battery pack.

In another embodiment according to the present disclosure, and with reference to the figures, an electronic circuit 100 for managing battery cells in a battery pack circuit for reducing stored energy in the circuit which can include the failed or compromised battery pack includes a plurality of battery packs 104 electrically connected in a circuit 100 in a battery system 100 to provide a system output voltage 102. Each of the battery packs includes a plurality of battery cells connected in an electrically conductive circuit, and each of the battery packs is generative of a pack output voltage collectively resulting in the system output voltage. The circuit can include a device being electrically communicable with the circuit and being capable of detection when a cell of the plurality of battery cells of a battery pack of the battery packs meets a threshold of a thermal state related to a battery capacity. The device has the capability to initiate discharge of electrical capacity of remaining cells other than the cell in the battery pack, thereby reducing available energy in the battery pack.

### Additional Examples and Embodiments

Referring to the figures, and for example, FIG. 3, a system 500 can include a computer in which can be integral to or communicating with a device 504, and communicate with other computers such as computer 590 or computer 572. A computer 590 remote from the battery pack 104 can electronically communicate, in all or in part, with a computer 572 as part of a control system 570. The control system 570 can include the computer 572 having a computer readable storage medium 573 which can store one or more programs 574, and a processor 575 for executing program instructions, and can also include control software for managing the one or more programs. Additional data can be stored on a storage medium 580 which is part of the control system 570.

The control system can also communicate with a computer system 590 which can include a learning engine/module 592 and a knowledge corpus or database 596. The computer system 590 can also communicate with the computer 572. In another example, the computer system 590 can be all or part of the control system. The depiction of the computer system 570 as well as the other components of the system 500 are shown as one example according to the present disclosure. One or more computer systems can communicate with a communications network 560, e.g., the Internet. For example, a computer of the device 504 can communicate with the communications network 560 and the control system 570, and the computer 572.

In one example, an AI (Artificial Intelligence) ecosystem, or technology/communication or IT (Information Technology) ecosystem can include a local communications network which can communicate with the communications network 560. The system 500 can include a learning engine/module 592, which can be at least part of the control system or communicating with the control system, for generating a model 593 or learning model. The learning engine can communicate with a knowledge corpus 596.

In general, a computer for facilitating the functions of the present disclosure can be part of a mobile device, or a remote computer communicating with the mobile device. In another example, a mobile device and a remote computer can work in combination to implement the method of the present disclosure using stored program code or instructions to execute the features of the method(s) described herein. In one example, a device can include a computer having a processor and a storage medium which stores an application, and the computer includes a display. The application can incorporate program instructions for executing the features of the present disclosure using the processor. In another example, the mobile device application or computer software can have program instructions executable for a front end of a software application incorporating the features of the method of the present disclosure in program instructions, while a back end program or programs, of the software application, stored on the computer of the control system communicates with the mobile device computer and executes other features of the method. The control system and the device (e.g., mobile device or computer) can communicate using a communications network, for example, the Internet.

Methods and systems according to embodiments of the present disclosure, can be incorporated, in whole or in part, in one or more computer programs or an application stored on an electronic storage medium, and executable by the processor, as part of the computer on mobile device. For example, a mobile device can communicate with the control system, and in another example, a device such as a video feed device can communicate directly with the control system. Other users (not shown) may have similar mobile devices which communicate with the control system similarly. The application can be stored, all or in part, on a computer or a computer in a mobile device and at a control system communicating with the mobile device, for example, using the communications network, such as the Internet. It is envisioned that the application can access all or part of program instructions to implement the method of the present disclosure. The program or application can communicate with a remote computer system via a communications network (e.g., the Internet) and access data, and cooperate with program(s) stored on the remote computer system. Such interactions and mechanisms are described in further detail herein and referred to regarding components of a computer system, such as computer readable storage media, which are shown in one or more embodiments herein and described in more detail in regards thereto referring to one or more computers and systems described herein.

Also, referring to the figures, a device can include a computer, computer readable storage medium, and operating systems, and/or programs, and/or a software application, which can include program instructions executable using a processor. Embodiments of these features are shown herein in the figures. The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

The program(s) can include, all or in part, a series of executable steps for implementing the method of the present disclosure. A program, incorporating the present method, can be all or in part stored in the computer readable storage medium on the control system or, in all or in part, on a computer or device. It is envisioned that the control system can not only store the profile of users, but in one embodiment, can interact with a website for viewing on a display of a device such as a mobile device, or in another example the Internet, and receive user input related to the method and system of the present disclosure. It is understood that embodiments shown in the figures depicts one or more profiles, however, the method can include multiple profiles, users, registrations, etc.

In one example, received data can include data in a knowledge corpus and historical database, which can be populated by historical data gathered, for example, from sensors, robotic device, or other machines or devices. Referring to one or more embodiments in the figures, a computer or a device, also can be referred to as a user device or an administrator's device, includes a computer having a processor and a storage medium where an application can be stored. The application can embody the features of the method of the present disclosure as instructions. The user can connect to a learning engine using the device. The device which includes the computer and a display or monitor. The application can embody the method of the present disclosure and can be stored on the computer readable storage medium. The device can further include the processor for executing the application/software. The device can communicate with a communications network, e.g., the Internet.

Additionally, methods and systems according to embodiments of the present disclosure can be discussed in relation to a functional system(s) depicted by functional block diagrams. The methods and systems can include components and operations for embodiments according to the present disclosure, and is used herein for reference when describing the operational steps of the methods and systems of the present disclosure. Additionally, the functional system, according to an embodiment of the present disclosure, depicts functional operations indicative of the embodiments discussed herein.

### More Examples and Embodiments

The methods and systems of the present disclosure can include a series of operational blocks for implementing one or more embodiments according to the present disclosure. A method shown in the figures may be another example embodiment, which can include aspects/operations shown in another figure and discussed previously, but can be reintroduced in another example. Thus, operational blocks and system components shown in one or more of the figures may be similar to operational blocks and system components in other figures. The diversity of operational blocks and system components depict example embodiments and aspects according to the present disclosure. For example, methods shown are intended as example embodiments which can include aspects/operations shown and discussed previously in the present disclosure, and in one example, continuing from a previous method shown in another flow chart.

It is understood that the features shown in some of the figures, for example block diagrams, are functional representations of features of the present disclosure. Such features are shown in embodiments of the systems and methods of the present disclosure for illustrative purposes to clarify the functionality of features of the present disclosure.

### Further Discussion Regarding Examples and Embodiments

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants.

### Still Further Embodiments and Examples

A computer implemented method as disclosed herein can include modeling, using the computer. The model can be generated using a learning engine or modeling module of a computer system which can be all or in part of an Artificial Intelligence (AI) system which communicates with the computer and/or a control system. Such a computer system can include or communicate with a knowledge corpus or historical database. In one example, an acceptable model can include a model meeting specified parameters. In another example, an acceptable model can be a model which has undergone several iterations of modeling. When the model is not acceptable, the method can return to return to a previous operation or proceed as directed, for example as represented by a operational block in a flowchart.

In one example according to the present disclosure, a method can generate a model, using a computer, which can include a series of operations. The model can be generated using a learning engine or modeling module of a computer system which can be all or in part of an Artificial Intelligence (AI) system which communicates with a computer and/or a control system. Such a computer system can include or communicate with a knowledge corpus or historical database.

The model can be generated using a learning engine or modeling module of a computer system which can be all or in part of an Artificial Intelligence (AI) system which communicates with a computer and/or a control system. Such a computer system can include or communicate with a knowledge corpus or historical database. A model can also be generated by an AI system such as an output at least in part of an AI system analysis using machine learning.

### Other Additional Embodiments and Examples

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### More Additional Examples and Embodiments

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 5, a computing environment 1000 contains an example of an environment for the execution of at least some of the computer code involved in performing the inventive methods, such as managing battery cells in a battery pack circuit for reducing available stored energy 1200. In addition to block 1200, computing environment 1000 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1200, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 7. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1200 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

It is also understood that the one or more computers or computer systems shown in the figures can include all or part of a computing environment and its components shown in another figure, for example, the computing environment 1000 can be incorporated, in all or in part, in one or more computers or devices shown in other figures and described herein. In one example, the one or more computers can communicate with all or part of a computing environment and its components as a remote computer system to achieve computer functions described in the present disclosure.

What is claimed is:

1. A method for managing battery cells in a battery pack circuit for reducing stored energy, comprising:
electrically connecting a plurality of battery packs in a circuit in a battery system providing a system output voltage, each of the battery packs including a plurality of battery cells connected in an electrically conductive circuit, each of the battery packs generating a pack output voltage collectively resulting in the system output voltage; and
in response to detecting when a cell of the plurality of battery cells of a battery pack of the battery packs meets a threshold of a thermal state related to a battery capacity, discharging electrical capacity of remaining cells other than the cell in the battery pack, thereby reducing available energy in the battery pack.

2. The method of claim 1, further comprising:
electrically isolating the cell which approached the threshold of the thermal state; and
maintaining the electrically conductive circuit of the remaining cells in the battery pack.

3. The method of claim 2, further comprising:
boosting a pack output voltage of the remaining cells to an output voltage usable to the battery system.

4. The method of claim 3, wherein the usable output voltage is within a range of voltages.

5. The method of claim 2, further comprising:
discontinuing electrical continuity of the cell within the plurality of battery cells connected in the electrically conductive circuit.

6. The method of claim 5, wherein the discontinuing of the electrical continuity of the cell includes removing charging and discharging capabilities, respectively, of the cell.

7. The method of claim 2, further comprising:
electrically disconnecting the battery pack from the battery system;
boosting a pack output voltage of the remaining cells to an output voltage usable to the battery system; and
reconnecting the battery pack to the battery system.

8. The method of claim 1, wherein the thermal state of the cell is a thermal runaway state of the cell.

9. The method of claim 1, wherein the reduction of the available energy in the battery pack reduces the likelihood of the thermal runaway state of the cell initiating a thermal runaway state in the remaining cells of the battery pack.

10. The method of claim 1, wherein the battery packs are Li-Ion (Lithium Ion) battery packs.

11. The method of claim 1, wherein the battery packs are connected in parallel in the battery system.

12. The method of claim 1, wherein the battery cells are connected in a parallel-series configuration.

13. The method of claim 1, further comprising:
electrically connecting the remaining cells using a multiplexer.

14. The method of claim 1, further comprising:
discharging electrical capacity of the cell.

15. The method of claim 1, further comprising:
a computer system managing the electrically connecting of the plurality of battery packs in the circuit in the battery system, and the computer system managing the discharging of the electrical capacity of the remaining cells in response to the detecting when the cell meets the threshold of the thermal state.

16. The method of claim 15, further comprising:
receiving, at the computer system, data input from the battery system indicating a connection state of the battery packs in the circuit;
receiving, at the computer system, cell data input from each of a plurality of cells of each of the battery packs; and
determining, at the computer system, in response to the detecting when the cell meets the threshold of the thermal state, the discharging of the electrical capacity of the remaining cells in the battery pack.

17. The method of claim 1, further comprising:
generating a digital model, using a computer, the digital model simulating the functions of;
the connecting of the plurality of battery pack in the circuit in the battery system; and
the discharging of the electrical capacity of remaining cells in the battery pack in response to the detecting when the cell meets the threshold of the thermal state.

18. The method of claim 17, further comprising:
iteratively generating the digital model to produce updated models.

19. A system for managing battery cells in a battery pack circuit for reducing stored energy, which comprises:
a computer system comprising; a computer processor, a computer-readable storage medium, and program instructions stored on the computer-readable storage medium being executable by the processor, to cause the computer system to perform the following functions to;
connect electrically a plurality of battery packs in a circuit in a battery system providing a system output voltage, each of the battery packs including a plurality of battery cells connected in an electrically conductive circuit, each of the battery packs generating a pack output voltage collectively resulting in the system output voltage;
a device electrically communicable with the circuit being capable of detecting electric capacity of a cell of the plurality of battery cells of a battery pack; and
in response to a detection, using the device, when the cell of the battery pack meets a threshold of a thermal state related to the electric capacity, discharge electrical capacity of remaining cells other than the cell in the battery pack, thereby reducing available energy in the battery pack.

20. A computer program product for managing battery cells in a battery pack circuit for reducing stored energy, the computer program product comprising a computer readable storage medium having program instructions embodied therewith, the program instructions executable by a computer to cause the computer to perform functions, by the computer, comprising the functions to;
connect electrically a plurality of battery packs in a circuit in a battery system providing a system output voltage, each of the battery packs including a plurality of battery cells connected in an electrically conductive circuit, each of the battery packs generating a pack output voltage collectively resulting in the system output voltage; and
in response to detecting when a cell of the plurality of battery cells of a battery pack of the battery packs meets a threshold of a thermal state related to a battery capacity, discharging electrical capacity of remaining cells other than the cell in the battery pack, thereby reducing available energy in the battery pack.

21. An electronic circuit for managing battery cells in a battery pack circuit for reducing stored energy, which comprises:
a plurality of battery packs electrically connected in a circuit in a battery system to provide a system output voltage, each of the battery packs includes a plurality of battery cells connected in an electrically conductive circuit, each of the battery packs being generative of a pack output voltage collectively resulting in the system output voltage;
a device being electrically communicable with the circuit and being capable of detection of a battery capacity when a cell of the plurality of battery cells of a battery pack of the battery packs meets a threshold of a thermal state related to the battery capacity; and
the device having capability to initiate discharge of electrical capacity of remaining cells other than the cell in the battery pack, thereby reducing available energy in the battery pack.
